(19) United States
(12) Patent Application Publication
(10) Pub. No.: US 2001/0049621 A1
(43) Pub. Date: Dec. 6, 2001

(54) Benchmarking surveys

(76) Inventor: Paul Raposo, San Francisco, CA (US)

Correspondence Address: Paul Raposo, 2 Townsend Street #1-209, San Francisco, CA, 94107, US

(21) Appl. No.: 09/851,624

(22) Filed: May 8, 2001

Related U.S. Application Data
(60) Provisional application No. 60/203,136, filed on May 8, 2000.

(51) Int. Cl. G06F 17/60

(52) U.S. Cl. 705/10

(57) ABSTRACT

Methods and machines that provide for creation of surveys with a variety of questions. Each survey is assigned goals. Each question is weighted toward the goals. The results of each response to a survey can be tallied to determine an index. The index can be correlated with the indices of other related surveys to produce a graph of the trends of the success toward the goals.

### RELATED APPLICATIONS

This application claims priority based on a provisional patent application entitled “Benchmarking Surveys,” filed May 8, 2000 Ser. No. 60/203,136, which is included herein by reference.

### BACKGROUND—FIELD OF THE INVENTION

This invention relates to benchmarking different surveys, specifically benchmarking of Internet based surveys.

### BACKGROUND—SURVEYS

Surveys or polls are commonly used to collect information. Over time a survey may be modified. Also once a survey is complete another different survey may be used to collect follow-up information. It is difficult to compare different surveys. It would be valuable to be able to simply see the results of a survey as a number or an index that would have meaning over time.

### SUMMARY OF THE INVENTION

In accordance with the present invention a method of creating benchmarks for surveys which can be used to graphically display over time and over multiple different surveys an overall trend.

### OBJECTS AND ADVANTAGES

Accordingly, beside the objects and advantages of the method described in my patent above, some additional objects and advantages of the present invention are:

1. to provide a method of assigning goals and weights to survey elements.

2. to provide a method of determining an index based on survey results against said goals and weights

3. to provide a graphical view of the index of related surveys over time to show trends.

4. to provide a professional web-based survey system that supports various types of survey questions and also supports the necessary goals and weights necessary to produce an index for each survey..

### DRAWING FIGURES

In the drawings, closely related figures have the same number but different alphabetic suffixes.

FIG. 1 the survey system process flow including the provisions for benchmarking.

Reference Numerals in Drawings

| | |
|---|---|
| 100 | secure server |
| 110 | server web site |
| 120 | respondent member |
| 130 | client user |
| 140 | panelist |
| 150 | client web site |
| 160 | survey target |
| 170 | network |
| 180 | survey builder |

### DESCRIPTION OF THE INVENTION

Surveys are all different, even different versions of the same survey. These differences can be due to questions added, questions removed or questions modified. Question modifications can include changing wording, changing options or changing types (changing a close ended question to an open ended question and vice versa).

Benchmarks provide a quantifiable way to conceptually grade and measure the success of a survey against goals. These benchmarks transcend surveys and differences within these surveys including question changes and wording. The benchmark is an index that works in much the same way that a stock market index works (by selecting key stocks, weighting them and monitoring their activity as an indication of the overall stock market activity).

It is not uncommon for surveys to be conducted more than once. Not only can benchmarking help measure the objectives of a survey and compare surveys, but also, by tracking them over time, measure progress towards overall market research objectives.

### How Benchmarks Work?

As part of the survey design, clients can define benchmarks. Goals and weights are used to evaluate an index that quantifies the “success” of the survey. The index works in much the same way that a stock market index works (by selecting key stocks, weighting them and monitoring their activity as an indication of the overall stock market activity). Target values can be assigned to any number of questions on the survey. Weights are then applied to these questions indicating the impact any one question has on the overall survey index, relative to other questions on the survey. An index is then calculated for every survey that is completed by a respondent.

The index is a percentage that indicates the proximity of the survey answers to the desired goals with 100% indicating that the completed survey likely meets the desired goals. The index can then be used to compare or rank surveys.

### The Survey System

The Survey System is a turnkey market research application, available as a subscription-based service through secure Internet access. The service may be accessed from anywhere, anytime through a browser or as a stand alone application. As an Application Service Provider (ASP), the service is the only cost. There is no need to purchase hardware, database and application software; they are all included. This service utilizes the system's proprietary technology to deliver a robust, cost-effective and intuitive method for conducting all types of traditional (paper and telephone) and web-based market research:

1. Attitude and Usage

2. Concept Testing

3. Advertising Testing

4. Package/Design Testing

5. Employee Satisfaction/Feedback

6. Promotion Testing

7. New Product Testing

8. Customer Satisfaction

9. Product Registration

10. Respondent Screening

The Survey System addresses many of the issues plaguing the market research industry today. Research professionals will have the ability to focus on performing research without the current headaches and expenses associated with the acquisition and management of the technology and resources regularly required to perform research tasks in-house. The Survey System is the complete, turnkey market research solution available from anywhere, anytime.

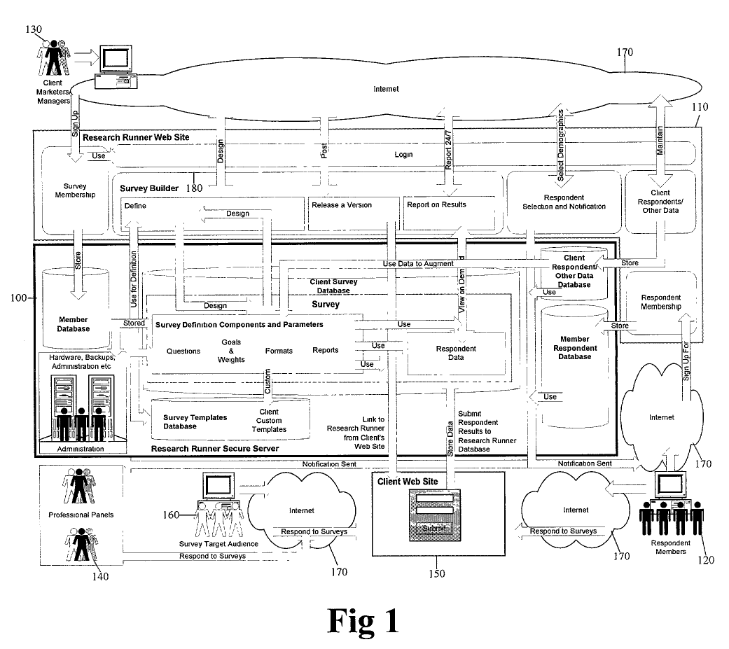

### FIG. 1—Survey System Process Flow

FIG. 1 illustrates the process flow of Survey System. The survey system comprises a secure server 100, a server web site 110, a client web site 150, each connect to a network 170.

The secure server 100 comprises a member database, a client survey database, survey templates database, a client respondent/other data database, and a respondent member database.

Client users 130, namely client marketers and managers, signup for membership, design, post, and obtain reports, select respondent demographics, and maintain client responding and other data via the server web site 110.

Individuals who are interested in taking surveys, namely respondent members 120, sign up as respondent members 120 via the server web site 110 and when notified of a survey request and then respond to the survey via the client web site 150

Individuals who match the desired demographics, namely survey targets 160, are notified of a survey request and then respond to the survey via the client web site 150.

Professional who have shown a particular understanding or discernment on a subject and invited to be part of a panel. These panelists 140 are notified of a survey request and then respond to the survey via the client web site 150. Panelist may be paid for their participation on the panel.

The survey builder 180 provides a means for client users 130 to define, post a version of a survey, and obtain instant, concurrent results. The survey system allows for certain goals and weights to be associated with a survey. Each version of a survey is benchmarked based on the response's relationship to the goals. These responses contribute to an index or benchmark for a survey. The benchmark can be charted over time and over various version of a survey or set of surveys to determine valuable trend information.

### Best Mode

The best mode implementation for this invention is an Oracle database server with a database format as shown in FIG. 1. This server would implement a number of programs that would allow researchers to create surveys comprising a number of different survey questions of various types. The researcher would assign goals for a survey and assign weights to the answers to each question. The results for multiple respondents would be tallied and the weights applied to determine an index. Further versions of a survey or surveys with similar goals could be correlated by the index. The programs would display the indexes of various surveys in the form of a graph. All survey creation tools, the surveys themselves, and the reports including the indexes would be available from the system via the World Wide Web or via stand-alone client applications.

### Conclusion, Ramification, and Scope

Accordingly, the reader will see that the survey system with the built in benchmarking and index graphs of the present invention provides a means of creating surveys, assigning goals and weights, tallying results to determine an index, and graphic related indexes to show trends.

Furthermore, the present invention has additional advantages in that:

(a) it provides a robust survey creation tool;

(b) it provides for almost instant results of surveys, especially web-based surveys;

(c) it provides a way for research to easily modify an existing survey and the correlate data from it with that collected via an early survey;

Although the descriptions above contain many specifics, these should not be construed as limiting the scope of the invention but as merely providing illustrations of some of the preferred embodiments of this invention. For example, the format of the index graphs can have different styles and the same relative operation, relative performance, and relative perceived value will result. Also, these processes can each be implemented as a hardware apparatus that will improve the performance significantly.

Thus the scope of the invention should be determined by the appended claims and their legal equivalents, and not solely by the examples given.

I claim:

1. A survey system whereby versions of a survey is benchmarked.

2. The system of claim 1 comprising:
(a) a secure server
(b) a server web site

3. The system of claim 2 further comprising a client web site

4. The server of claim 2 further comprising a member database.

5. The server of claim 2 further comprising a respondent database.

6. The server of claim 2 further comprising a client respondent/other data database.

7. The system of claim 1 further comprising a survey builder.

8. A method of taking a survey whereby a benchmark is maintained comprising the steps of:
(a) designing a survey with goals and weights
(b) releasing said survey
(c) creating a benchmark based on survey results
(d) storing said benchmark associated with said survey

9. The method of claim 8 further comprising a step of selecting demographics for a survey target.

10. The method of claim 8 further comprising a step of generating a graph based on said benchmark.

11. The method of claim 8 wherein said survey results are obtained from a plurality of individuals who have entered into an agreement to respond to surveys.

12. The method of claim 11 wherein said individuals are respondent members, having provided demographic along with said agreement.

13. The method of claim 11 wherein said individuals are panelists, having been selected based on particular characteristics.

14. The method of claim 13 wherein said individuals are panelists are compensated for the participation.
